(19) United States
(12) Patent Application Publication
(10) Pub. No.: US 2026/0149579 A1
(43) Pub. Date: May 28, 2026

(54) GENERATION OF CONCEALED SUBSCRIPTION IDENTITIES FOR USER EQUIPMENT

(71) Applicant: Lenovo (United States) Inc., Morrisville, NC (US)

(72) Inventors: Andreas KUNZ, Ladenburg (DE); Sheeba Backia Mary BASKARAN, Friedrichsdorf (DE)

(21) Appl. No.: 19/446,411

(22) Filed: Jan. 12, 2026

(51) Int. Cl. H04L 9/08; H04L 9/32

(52) U.S. Cl. CPC H04L 9/088; H04L 9/3236

(57) ABSTRACT

Various aspects of the present disclosure relate to a mechanism that stores, for every subscription (e.g., each subscription permanent identifier, or SUPI, for subscribers of a network) individual key identifiers for the subscription in a reverse hash chain. For example, the mechanism, employed by a UE, may utilize a key identifier nonce and a key identifier hash chain length, generate a hash chain using the key identifier nonce as an initial value, where the hash chain has the key identifier hash chain length, select a last key identifier from the hash chain as a key identifier for a root key, and generate a concealed identifier for the UE using the root key (or a key derived from the root key).

### TECHNICAL FIELD

The present disclosure relates to wireless communications, and more specifically to generating concealed subscription identities for user equipment (UEs).

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for generating concealed subscription identities for UEs.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network function, a message that comprises a key identifier nonce and a key identifier hash chain length, generate a hash chain using the key identifier nonce as an initial value, wherein the hash chain has the key identifier hash chain length, select a last key identifier from the hash chain as a key identifier for a root key, generate a concealed identifier for the UE using the root key or a key derived from the root key, and transmit a message including the concealed identifier.

A processor for wireless communication is described. The processor may be configured to, capable of, or operable to perform one or more operations as described herein. For example, the processor may comprise at least one memory and at least one controller coupled with the at least one memory and configured to cause the processor to receive, from a network function, a message that comprises a key identifier nonce and a key identifier hash chain length, generate a hash chain using the key identifier nonce as an initial value, wherein the hash chain has the key identifier hash chain length, select a last key identifier from the hash chain as a key identifier for a root key, generate a concealed identifier for the UE using the root key or a key derived from the root key, and transmit a message including the concealed identifier.

A method performed or performable by the UE is described. The method may comprise receiving, from a network function, a message that comprises a key identifier nonce and a key identifier hash chain length, generating a hash chain using the key identifier nonce as an initial value, wherein the hash chain has the key identifier hash chain length, selecting a last key identifier from the hash chain as a key identifier for a root key, generating a concealed identifier for the UE using the root key or a key derived from the root key, and transmitting a message including the concealed identifier.

In some implementations of the UE, processor, and method described herein, the UE, processor, and method may further be configured to, capable of, performed, performable, or operable to, before receiving the message from the network function, transmit, to the network function, a registration request message that comprises an initial key identifier for the UE and the concealed identifier.

In some implementations of the UE, processor, and method described herein, the initial key identifier is a default key identifier, the last key identifier from the hash chain, or an intermediate key identifier from the hash chain.

In some implementations of the UE, processor, and method described herein, the concealed identifier is a subscription concealed identifier (SUCI).

In some implementations of the UE, processor, and method described herein, the hash chain is a truncated hash chain and the key identifier hash chain length is a truncated key identifier hash chain length.

In some implementations of the UE, processor, and method described herein, the UE, processor, and method may further be configured to, capable of, performed, performable, or operable to generate the hash chain by performing multiple hash functions, using the key identifier nonce as an initial input, to output a hash chain having a first key identifier, one or more intermediate key identifiers, and the last key identifier, wherein a quantity of multiple hash functions is based on the key identifier hash chain length.

In some implementations of the UE, processor, and method described herein, the UE, processor, and method may further be configured to, capable of, performed, performable, or operable to truncate the first key identifier, the one or more intermediate key identifiers, and the last key identifier after outputting the last key identifier.

In some implementations of the UE, processor, and method described herein, the UE, processor, and method may further be configured to, capable of, performed, performable, or operable to truncate an output of each performed hash function of the multiple hash functions before performing a subsequent hash function.

A network function for wireless communication is described. The network function may be configured to, capable of, or operable to perform one or more operations as described herein. For example, the network function may comprise at least one memory and at least one processor coupled with the at least one memory and configured to cause the network function to receive an authentication request message that comprises a concealed identifier for a UE and a key identifier, select a subscription profile and a root key based on the key identifier, de-conceal the concealed identifier to a permanent identifier using the root key or a key derived from the root key, and transmit an authenticated response message that includes the permanent identifier.

A method performed or performable by the network function is described. The method may comprise receiving an authentication request message that comprises a concealed identifier for a UE and a key identifier, selecting a subscription profile and a root key based on the key identifier, de-concealing the concealed identifier to a permanent identifier using the root key or a key derived from the root key, and transmitting an authenticated response message that includes the permanent identifier.

In some implementations of the network function and method described herein, the network function and method may further be configured to, capable of, performed, performable, or operable to generate a key identifier nonce, generate a hash chain having a key identifier hash chain length based on the key identifier nonce, and transmit, via the authenticated response message, the key identifier nonce and the key identifier hash chain length.

In some implementations of the network function and method described herein, the network function and method may further be configured to, capable of, performed, performable, or operable to truncate the hash chain to generate a truncated hash chain, wherein the key identifier hash chain length is a truncated key identifier hash chain length.

In some implementations of the network function and method described herein, the concealed identifier is a SUCI, and the permanent identifier is a subscription permanent identifier (SUPI).

In some implementations of the network function and method described herein, the key identifier is a default key identifier default key identifier, a last key identifier from a previously generated hash chain, or an intermediate key identifier from the previously generated hash chain.

In some implementations of the network function and method described herein, the network function is a unified data management (UDM) function, a subscription identity de-concealing function (SIDF), or an Authentication credential Repository and Processing Function (ARPF).

### BRIEF DESCRIPTION OF THE DRAWINGS

FIG. 1 illustrates an example of a wireless communications system in accordance with aspects of the present disclosure.

FIG. 2 illustrates an example of an enhanced subscription profile in accordance with aspects of the present disclosure.

FIG. 3 illustrates an example messaging flow in accordance with aspects of the present disclosure.

FIGS. 4A-4B illustrate examples of hash chain generation in accordance with aspects of the present disclosure.

FIGS. 5A-5B illustrate example messaging flows in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

A wireless communications system may utilize various mechanisms for concealing a subscription permanent identifier (SUPI) associated with a UE, such as to avoid transmissions of the SUPI in an unprotected or un-ciphered (e.g., in clear text) manner over an air interface. For example, the concealment of a SUPI may be based on different encryption schemes, such as the Elliptic Curve Integration Encryption Scheme (ECIES).

Different radio access technologies may utilize other encryption schemes. For example, the 6G RAT may deploy post-quantum secure cryptography (PQC) schemes, such as symmetric encryption schemes using 256 bit key lengths and asymmetric encryption schemes. These PQC SUPI protection mechanisms may utilize hybrid or symmetric schemes, such as schemes that calculate a subscription concealed identifier (SUCI) from a SUPI using a symmetric key.

Given that a root key K is different or unique for each SUPI, identification information for each UE is provided when generating root keys. However, issues may arise when identifying corresponding root keys for SUCIs in a UDM or other network function and/or when synchronizing or tracking key identifiers to SUCIs. In other words, no mechanism addresses the issue of key identification for symmetric SUPI encryption schemes.

The present disclosure provides a mechanism that stores, for every subscription (e.g., each SUPI) individual key identifiers for the subscription in a reverse hash chain. For example, the mechanism, employed by a UE, may utilize a key identifier nonce and a key identifier hash chain length, generate a hash chain having the key identifier hash chain length using the key identifier nonce as an initial value, select a last key identifier from the hash chain as a key identifier for a root key, and generate a concealed identifier for the UE using the root key (or a key derived from the root key). Thus, the UE can utilize the reverse hash chain to generate or select a root key when generating a SUCI for a SUPI, avoiding issues associated with key identification when applying symmetric encryption, among other benefits.

Aspects of the present disclosure are described in the context of a wireless communications system.

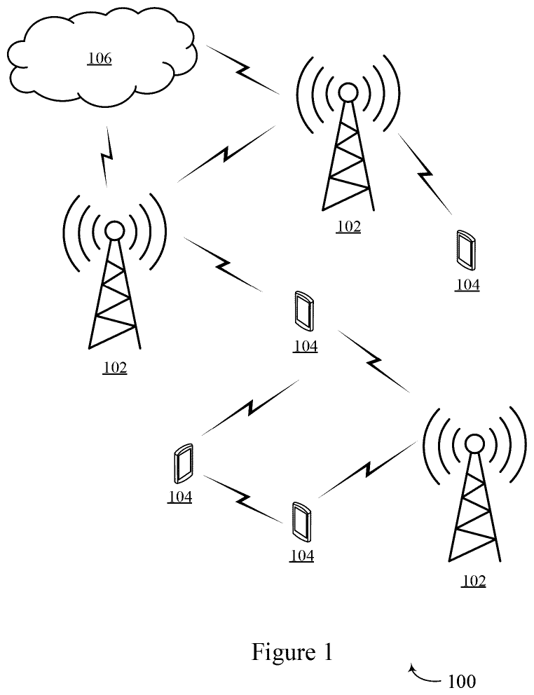

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20, and ISO 18000-6C UHF RFID. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), a reader device (e.g., AIoT reader, an RFID reader), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an AIoT device, an RFID tag, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may support a mechanism that stores, for every subscription (e.g., each SUPI) individual key identifiers for the subscription in a reverse hash chain. The hash chain may have a length that is configured by a mobile operator and include a series of key identifiers (e.g., truncated to, for example, 128 bits). Thus, when encrypting or concealing a SUPI (to obtain a SUCI), the UE 104 utilizes the key identifiers in reverse order, to avoid prediction or a next or selected value, among other benefits. The UE 104 may then transmit messages having a concealed identifier (e.g., the SUCI).

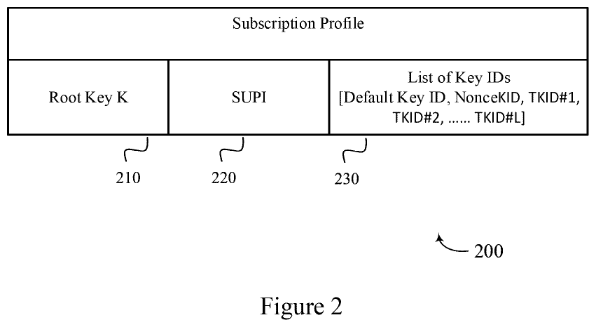

FIG. 2 illustrates an example of an enhanced subscription profile 200 in accordance with aspects of the present disclosure. For each subscription, a root key 210 and SUPI 220 are linked or associated with key identifiers 230 (e.g., a hash chain of key identifiers), such as a default key ID, a Nonce ID, intermediate key identifiers (e.g., TKID #1, TKID #2, and so on) from the hash chain, and a last key identifier (e.g., TKID #L) from the hash chain. The subscription profile may be stored by a UDM or other similar network function.

In some examples, the UE 104 may perform the symmetric SUPI encryption during an initial registration request with a network, such as by using a default key identifier to point to an associated subscription profile (e.g., the subscription profile 200) in the UDM and locate a root key K (e.g., the root key 210) during decryption of a SUCI to a SUPI.

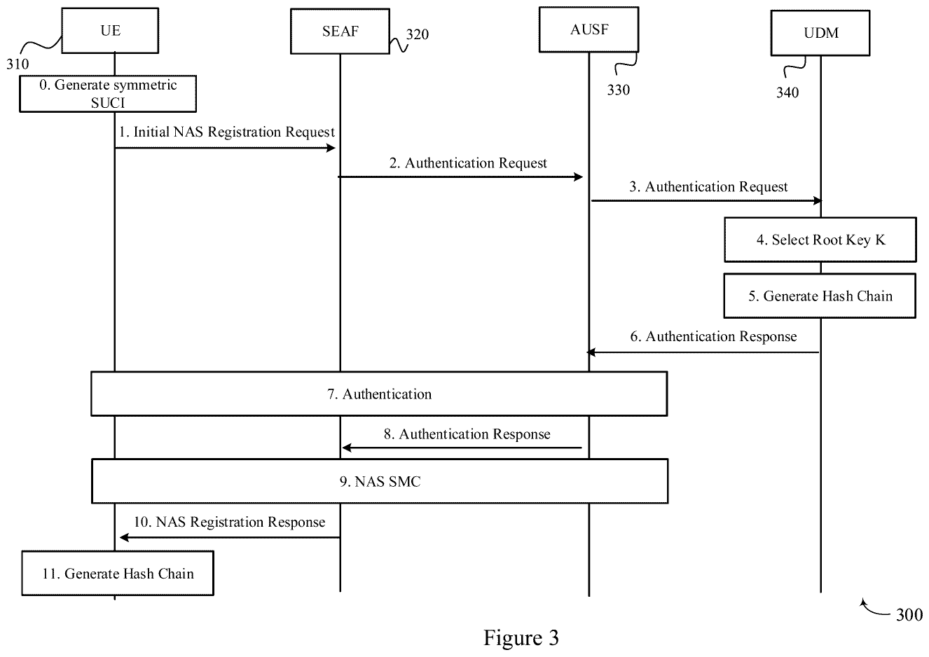

FIG. 3 illustrates an example messaging flow 300 in accordance with aspects of the present disclosure. The messaging flow 300 may include a UE 310, a security anchor function (SEAF) 320, an authentication server function (AUSF) 330, and a UDM 340 (or ARPF/SIDF), which may be examples of UEs, SEAFs, AUSFs, or UDMs, as described herein. In the following description of the messaging flow 300, the operations between the UE 310, the SEAF 320, the AUSF 330, and the UDM 340 may be performed in different orders or at different times. Some operations may also be omitted, or other operations may be added. Although the UE 310, the SEAF 320, the AUSF 330, and the UDM 340 are shown performing the operations of the messaging flow 300, some aspects of some operations may also be performed by other entities of the messaging flow 300 or by entities that are not shown in the messaging flow 300, or any combination thereof.

Before initiating a registration request, the UE 310, at step 0, generates a symmetric SUCI. For example, the UE 310 generates a nonce for SUPI encryption and performs a symmetric encryption of the SUPI to generate a SUCI using the root key K and the nonce. The nonce, which is part of the SUCI, may be used by the UDM 340 to decrypt the SUCI.

At step 1, the UE 310 sends an initial NAS registration request to the SEAF 320 (or an AMF). For example, the UE 310 sends the registration request with a default key identifier, which is to be used to locate a root key K (associated with the UE 310) in the UDM 340.

At step 2, the SEAF 320 sends an authentication request to the AUSF 330. For example, the SEAF 320 sends an Nausf_UEAuthentication_Authenticate request message including the Default Key Identifier and the SUCI, to the AUSF 330, to initiate an authentication of the UE 310.

At step 3, the AUSF 330 sends an authentication request to the UDM 340. For example, the AUSF 330 sends an Nudm_UEAuthentication_Get request message, including the SUCI, a serving network name, and the default key identifier, to the UDM 340.

At step 4, the UDM 340 (or ARPF/SIDF) selects a root key K. For example, the UDM 340 selects the root key K based on the default key identifier (e.g., from the subscription profile 200) and decrypts the SUCI to the SUPI according to the encryption scheme and using the nonce of the SUCI and the root key K.

At step 5, the UDM 340 generates a hash chain. For example, the UDM 340 generates a NonceKID as a root for a Key Identifier (KID) Hash Chain. In some cases, the NonceKID is a random number or a counter. The UDM 340 generates the KID Hash Chain by starting with a hash over the NonceKID, where a first KID #1 value is an output of the hash function, a second KID #2 value is an output of a hash of the first KID #1 value and so on, until a preconfigured or defined hash chain length L (e.g., a number or quantity of total key identifiers).

In some cases, the UDM 340 truncates the KID values to a smaller length (e.g., from 256 bits to 128 bits). For example, the UDM 340 may truncate all values directly after generation or truncate the values at the end to form a Truncated Key Identifier TKID Hash Chain. A last truncated value (TKID #L) of the Key ID Hash Chain is a next key identifier to be used for the root key K.

At step 6, the UDM 340 sends an authentication response to the AUSF 330. For example, the UDM 340 sends an Nudm_UEAuthentication_Get response that includes the SUPI, an Authentication Vector (AV), the NonceKID, and the hash chain length L.

At step 7, the AUSF 330 authenticates the UE 310. For example, the AUSF 330 performs an authentication with the UE 310 using Extensible Authentication Protocol Authentication and Key Agreement (EAP-AKA'), 5G-AKA, or other suitable authentication frameworks.

At step 8, the AUSF 330 sends an authentication response to the SEAF 320. For example, the AUSF 330 sends an Nausf_UEAuthentication_Authenticate response that includes an authentication result, the SUPI, a KSEAF, the NonceKID, and the hash chain length L.

At step 9, the SEAF 320 performs a NAS Security Mode Command (SMC) procedure with the UE 310.

At step 10, the SEAF 320 sends a NAS registration response to the UE 310. For example, the SEAF 320 sends an initial registration response that includes the NonceKID and the hash chain length L in a protected a NAS message to the UE 310.

At step 11, the UE 310 generates the hash chain. For example, as described with respect to step 5, the UE 310 generates the KID Hash Chain by starting with a hash over the NonceKID, where a first KID #1 value is an output of the hash function, a second KID #2 value is an output of a hash of the first KID #1 value and so on, until a preconfigured or defined hash chain length L (e.g., a number or quantity of total key identifiers). The UE 310 may truncate the KID values to a smaller length (e.g., from 256 bits to 128 bits), where the last truncated value (TKID #L) of the Key ID Hash Chain is a next key identifier to be used for the root key K.

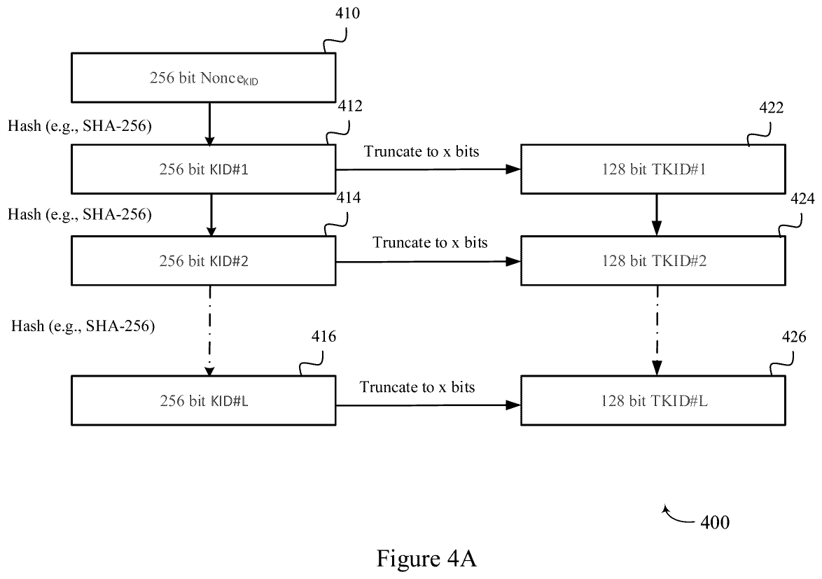

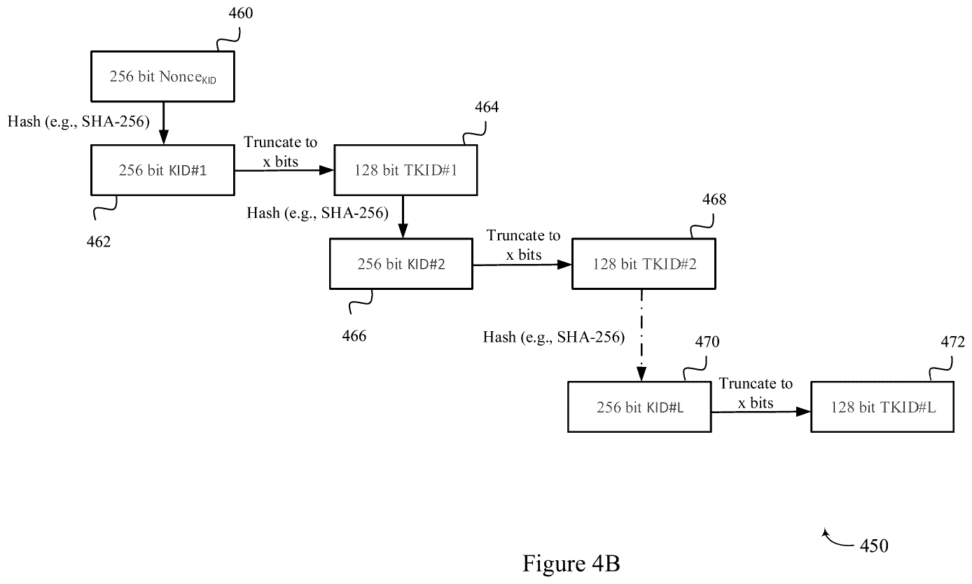

As described herein, the UE 310 and/or the UDM 340 may generate the TKID Hash Chain in a variety of ways. FIG. 4A illustrates a first example 400 for generating a truncated hash chain, where the UE 310 and/or UDM 340 performs a “hash first, truncate later” mechanism.

For example, the UE 310 and/or UDM 340 hashes (e.g., using a SHA-256 hashing function) an initial value 410 (e.g., NonceKID) to retrieve an output of a KID 412 (e.g., KID #1), such as an intermediate KID. The UE 310 and/or UDM 340 may perform a series of hashes of intermediate KIDs (e.g., hashing the KID 412 to output a KID 414, or KID #2), until a last KID 416 (e.g., a KID #L) is output, where L, the hash chain length, is equal to a total number or quantity of output KIDs.

The UE 310 and/or UDM 340 then truncates the KIDs 412, 414, 416. For example, the UE 310 and/or UDM 340 may truncate the 256 bit KIDs to the least or most significant x bits, where x is smaller than the output bits of the hash functions (e.g., where each TKID is the least significant 128 bits of the output hashes of its associated KID. Thus, the KID 412 is truncated to a TKID 422 (e.g., a 128 bit TKID #1), the KID 414 is truncated to a TKID 424 (e.g., a 128 bit TKID #2), and the KID 416 is truncated to a TKID 426 (e.g., a 128 bit TKID #L). As described herein, the UE 310 and/or the UDM 340 uses the TKIDs 422, 424, 426 in reverse order (e.g., first using the TKID #L) during root key generation.

FIG. 4B illustrates a second example 450 for generating a truncated hash chain, where the UE 310 and/or UDM 340 performs a “hash and truncate” mechanism. For example, the UE 310 and/or UDM 340 hashes (e.g., using a SHA-256 hashing function) an initial value 460 (e.g., NonceKID) to retrieve an output of a KID 462 (e.g., KID #1), such as an intermediate KID. The UE 310 and/or UDM 340 directly truncates, as described herein, the KID 462 to obtain a TKID 464 (e.g., a 128 bit TKID #1).

The TKID 464 is then input into a next hash function to output a next KID 466 (e.g., KID #2), and the UE 310 and/or UDM 340 truncates the KID 466 to obtain a next TKID 468 (e.g., TKID #2). The UE 310 and/or UDM 340 continues the sequence of hashing and truncation until a last KID 470 (e.g., a KID #L) is output, which is then truncated to obtain a last TKID 472 (e.g., a 128 bit TKID #L). Similar to the first example 400, UE 310 and/or the UDM 340 uses the TKIDs 464, 468, and 472 in reverse order (e.g., first using the TKID #L) during root key generation.

Of course, in some examples, the UE 310 and/or UDM 340 may not perform any truncation and utilize a hash chain for generating key identifiers that are not truncated (e.g., are 256 bit KIDs) when employed during root key generation.

Once an initial registration procedure (e.g., via the messaging flow 300) is performed, the UE 310 and/or UDM 340 may utilize TKIDs in different ways. In some examples, the UE 310 and/or UDM 340 may only use a latest or last TKID (e.g., TKID #L) for pointing to a root key and refresh a hash chain after use of the TKID #L. Thus, the other TKIDs (e.g., TKID #1, TKID #2, . . . , TKID #L-1) may be used only during network issues or other mitigating factors (with no repetitions of TKIDs).

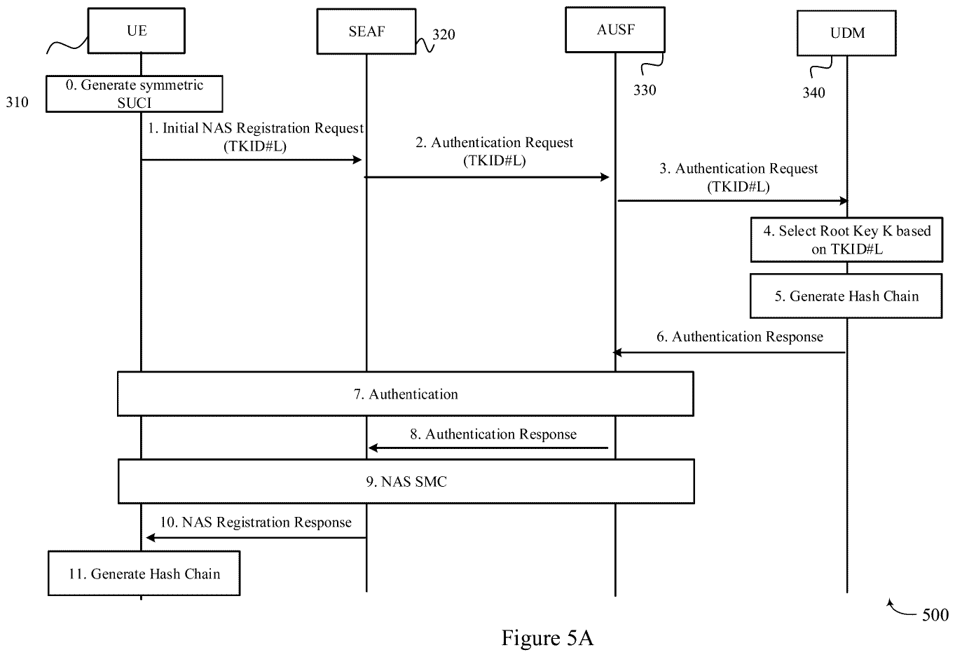

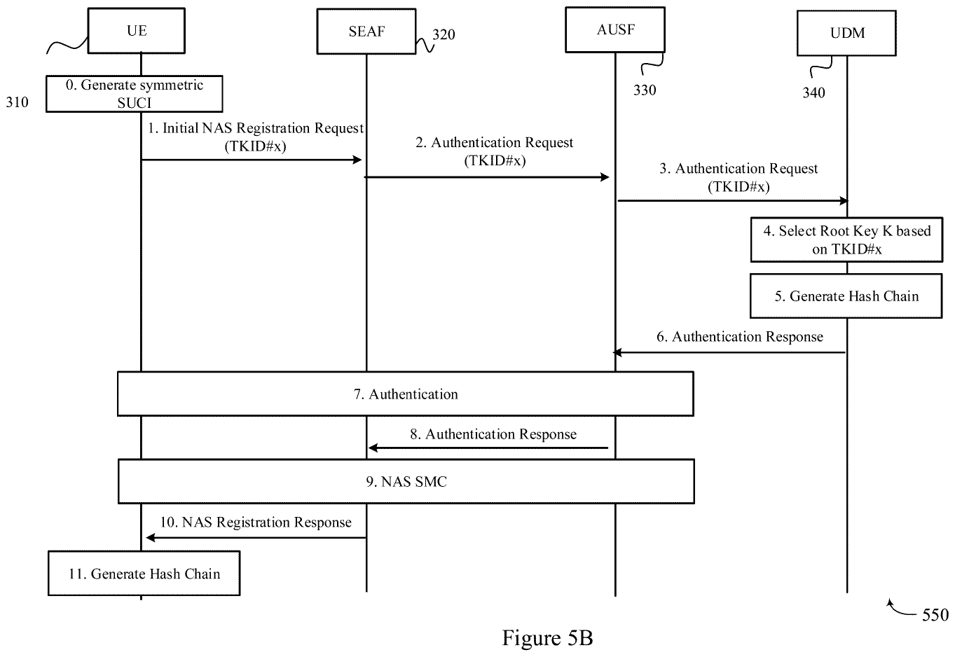

FIG. 5A illustrates an example messaging flow 500 in accordance with aspects of the present disclosure. The messaging flow 500 may include the UE 310, the SEAF 320, the AUSF 330, and the UDM 340 (or ARPF/SIDF), which may be examples of UEs, SEAFs, AUSFs, or UDMs, as described herein. In the following description of the messaging flow 500, the operations between the UE 310, the SEAF 320, the AUSF 330, and the UDM 340 may be performed in different orders or at different times. Some operations may also be omitted, or other operations may be added. Although the UE 310, the SEAF 320, the AUSF 330, and the UDM 340 are shown performing the operations of the messaging flow 500, some aspects of some operations may also be performed by other entities of the messaging flow 500 or by entities that are not shown in the messaging flow 500, or any combination thereof.

At step 1, the UE 310 sends an initial NAS registration request to the SEAF 320 (or an AMF). For example, the UE 310 sends the registration request with the TKID #L, which is to be used to locate a root key K (associated with the UE 310) in the UDM 340.

At step 2, the SEAF 320 sends an authentication request to the AUSF 330. For example, the SEAF 320 sends an Nausf_UEAuthentication_Authenticate request message including the TKID #L and the SUCI, to the AUSF 330, to initiate an authentication of the UE 310.

At step 3, the AUSF 330 sends an authentication request to the UDM 340. For example, the AUSF 330 sends an Nudm_UEAuthentication_Get request message, including the SUCI, a serving network name, and the TKID #L, to the UDM 340.

At step 4, the UDM 340 (or ARPF/SIDF) selects a root key K. For example, the UDM 340 selects the root key K based on the TKID #L and decrypts the SUCI to the SUPI according to the encryption scheme and using the nonce of the SUCI and the root key K.

At step 5, the UDM 340 generates a hash chain. For example, the UDM 340 generates a NonceKID as a root for a Key Identifier (KID) Hash Chain. In some cases, the NonceKID is a random number or a counter. The UDM 340 generates the KID Hash Chain by starting with a hash over the NonceKID, where a first KID #1 value is an output of the hash function, a second KID #2 value is an output of a hash of the first KID #1 value and so on, until a preconfigured or defined hash chain length L (e.g., a number or quantity of total key identifiers). In some cases, the UDM 340 truncates the KID values to a smaller length (e.g., from 256 bits to 128 bits). For example, the UDM 340 may truncate all values directly after generation or truncate the values at the end to form a Truncated Key Identifier TKID Hash Chain. A last truncated value (TKID #L) of the Key ID Hash Chain is a next key identifier to be used for the root key K.

At step 6, the UDM 340 sends an authentication response to the AUSF 330. For example, the UDM 340 sends an Nudm_UEAuthentication_Get response that includes the SUPI, an Authentication Vector (AV), the NonceKID, and the hash chain length L.

At step 7, the AUSF 330 authenticates the UE 310. For example, the AUSF 330 performs an authentication with the UE 310 using Extensible Authentication Protocol Authentication and Key Agreement (EAP-AKA′), 5G-AKA, or other suitable authentication frameworks.

At step 8, the AUSF 330 sends an authentication response to the SEAF 320. For example, the AUSF 330 sends an Nausf_UEAuthentication_Authenticate response that includes an authentication result, the SUPI, a KSEAF, the NonceKID, and the hash chain length L.

At step 9, the SEAF 320 performs a NAS Security Mode Command (SMC) procedure with the UE 310.

At step 10, the SEAF 320 sends a NAS registration response to the UE 310. For example, the SEAF 320 sends an initial registration response that includes the NonceKID and the hash chain length L in a protected a NAS message to the UE 310.

At step 11, the UE 310 generates the hash chain. For example, as described with respect to step 5, the UE 310 generates the KID Hash Chain by starting with a hash over the NonceKID, where a first KID #1 value is an output of the hash function, a second KID #2 value is an output of a hash of the first KID #1 value and so on, until a preconfigured or defined hash chain length L (e.g., a number of total key identifiers). The UE 310 may truncate the KID values to a smaller length (e.g., from 256 bits to 128 bits), where the last truncated value (TKID #L) of the Key ID Hash Chain is a next key identifier to be used for the root key K.

In some examples, the UE 310 may first use the TKID #L and then use other TKIDs in a hash chain (in the reverse order) when messaging a SUCI, until reaching the first TKID (e.g., TKID #1) or another configured number N of TKIDs (e.g., where 1≤N≤L). Once reached, the UDM 34 may assign a new nonce (e.g., NonceKID) and/or hash chain length L.

FIG. 5B illustrates an example messaging flow 550 in accordance with aspects of the present disclosure. The messaging flow 550 may include the UE 310, the SEAF 320, the AUSF 330, and the UDM 340 (or ARPF/SIDF), which may be examples of UEs, SEAFs, AUSFs, or UDMs, as described herein. In the following description of the messaging flow 550, the operations between the UE 310, the SEAF 320, the AUSF 330, and the UDM 340 may be performed in different orders or at different times. Some operations may also be omitted, or other operations may be added. Although the UE 310, the SEAF 320, the AUSF 330, and the UDM 340 are shown performing the operations of the messaging flow 550, some aspects of some operations may also be performed by other entities of the messaging flow 550 or by entities that are not shown in the messaging flow 500, or any combination thereof.

At step 1, the UE 310 sends an initial NAS registration request to the SEAF 320 (or an AMF). For example, the UE 310 sends the registration request with the TKID #x (where 1≤x≤L), which is to be used to locate a root key K (associated with the UE 310) in the UDM 340.

At step 2, the SEAF 320 sends an authentication request to the AUSF 330. For example, the SEAF 320 sends an Nausf_UEAuthentication_Authenticate request message including the TKID #x and the SUCI, to the AUSF 330, to initiate an authentication of the UE 310.

At step 3, the AUSF 330 sends an authentication request to the UDM 340. For example, the AUSF 330 sends an Nudm_UEAuthentication_Get request message, including the SUCI, a serving network name, and the TKID #x, to the UDM 340.

At step 4, the UDM 340 (or ARPF/SIDF) selects a root key K. For example, the UDM 340 selects the root key K based on the TKID #x and decrypts the SUCI to the SUPI according to the encryption scheme and using the nonce of the SUCI and the root key K.

At step 5, the UDM 340 generates a hash chain. For example, when the next TKID in the TKID Hash Chain (e.g., the TKID #x−1) is not the NonceKID or a preconfigured TKID #N with 1≤N≤L, then the UDM 340 selects TKID #x−1 as a next TKID to be used for the root key K. When the next TKID is the NonceKID or a preconfigured TKID #N with 1≤N≤L, then the UDM 340 generates a new NonceKID and generates a KID Hash Chain of length L. The UDM 340 generates the KID Hash Chain by starting with a hash over the NonceKID, where a first KID #1 value is an output of the hash function, a second KID #2 value is an output of a hash of the first KID #1 value and so on, until a preconfigured or defined hash chain length L (e.g., a number of total key identifiers).

At step 6, the UDM 340 sends an authentication response to the AUSF 330. For example, the UDM 340 sends an Nudm_UEAuthentication_Get response that includes the SUPI, an Authentication Vector (AV), the NonceKID, and the hash chain length L (when there was a newly generated KID Hash Chain)

At step 7, the AUSF 330 authenticates the UE 310. For example, the AUSF 330 performs an authentication with the UE 310 using Extensible Authentication Protocol Authentication and Key Agreement (EAP-AKA'), 5G-AKA, or other suitable authentication frameworks.

At step 8, the AUSF 330 sends an authentication response to the SEAF 320. For example, the AUSF 330 sends an Nausf_UEAuthentication_Authenticate response that includes an authentication result, the SUPI, a KSEAF, the NonceKID, and the hash chain length L (when there was a newly generated KID Hash Chain).

At step 9, the SEAF 320 performs a NAS Security Mode Command (SMC) procedure with the UE 310.

At step 10, the SEAF 320 sends a NAS registration response to the UE 310. For example, the SEAF 320 sends an initial registration response that includes the NonceKID and the hash chain length L in a protected a NAS message to the UE 310 (when there was a newly generated KID Hash Chain).

At step 11, the UE 310 generates the hash chain. For example, as described with respect to step 5, the UE 310 selects the TKID #x−1 with 1≤x−1≤L as a next TKID be used for the root key K when there is no hash chain length L or nonce in the NAS message). When the NAS message does include the hash chain length L or nonce, the UE 310, as described herein, generates a new NonceKID and generates a KID Hash Chain of length L.

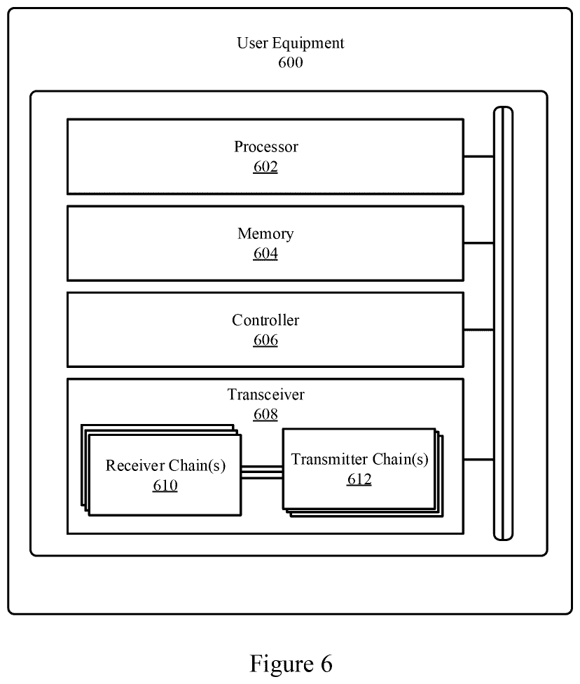

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving, from a network function, a message that comprises a key identifier nonce and a key identifier hash chain length, generating a hash chain using the key identifier nonce as an initial value, wherein the hash chain has the key identifier hash chain length, selecting a last key identifier from the hash chain as a key identifier for a root key, generating a concealed identifier for the UE using the root key or a key derived from the root key, and transmitting a message including the concealed identifier.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

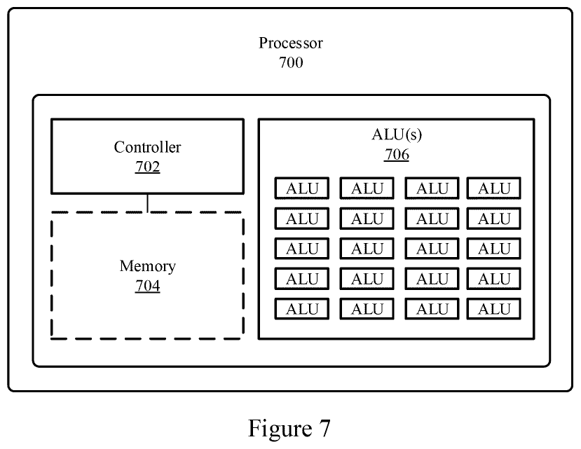

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to support a means for receiving, from a network function, a message that comprises a key identifier nonce and a key identifier hash chain length, generating a hash chain using the key identifier nonce as an initial value, wherein the hash chain has the key identifier hash chain length, selecting a last key identifier from the hash chain as a key identifier for a root key, generating a concealed identifier for the UE using the root key or a key derived from the root key, and transmitting a message including the concealed identifier.

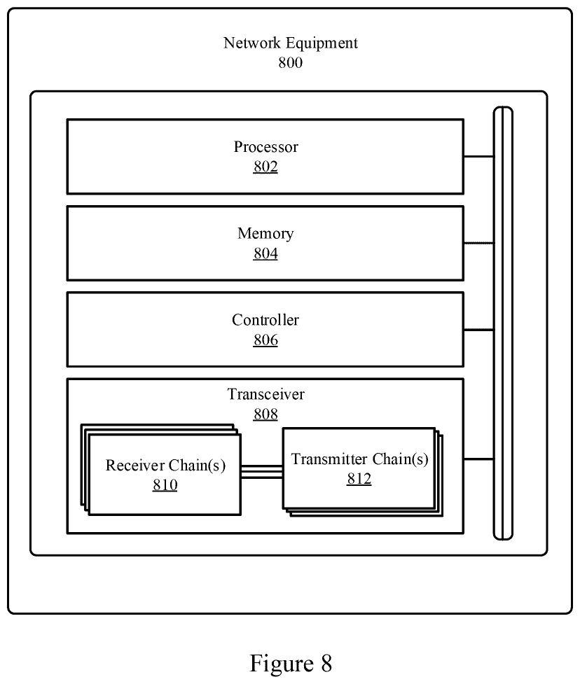

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving an authentication request message that comprises a concealed identifier for a UE and a key identifier; selecting a subscription profile and a root key based on the key identifier; de-concealing the concealed identifier to a permanent identifier using the root key or a key derived from the root key; and transmitting an authenticated response message that includes the permanent identifier.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

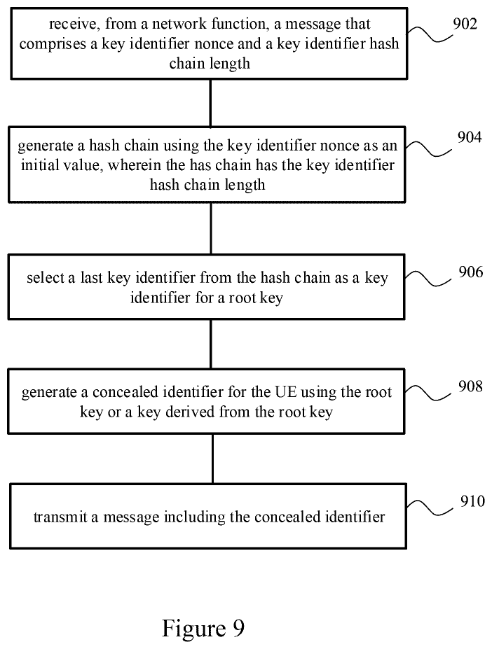

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving, from a network function, a message that comprises a key identifier nonce and a key identifier hash chain length. The operations of 902 may be performed in accordance with examples as described herein. In some implementations, aspects of the operations of 902 may be performed by a UE as described with reference to FIG. 6.

At 904, the method may include generating a hash chain using the key identifier nonce as an initial value, wherein the hash chain has the key identifier hash chain length. The operations of 904 may be performed in accordance with examples as described herein. In some implementations, aspects of the operations of 904 may be performed by a UE as described with reference to FIG. 6.

At 906, the method may include selecting a last key identifier from the hash chain as a key identifier for a root key. The operations of 906 may be performed in accordance with examples as described herein. In some implementations, aspects of the operations of 906 may be performed by a UE as described with reference to FIG. 6.

At 908, the method may include generating a concealed identifier for the UE using the root key or a key derived from the root key. The operations of 908 may be performed in accordance with examples as described herein. In some implementations, aspects of the operations of 908 may be performed by a UE as described with reference to FIG. 6.

At 910, the method may include transmitting a message including the concealed identifier. The operations of 910 may be performed in accordance with examples as described herein. In some implementations, aspects of the operations of 910 may be performed by a UE as described with reference to FIG. 6.

It should be noted that the method described herein describes a possible implementation, and that the operations and the steps may be rearranged or otherwise modified and that other implementations are possible.

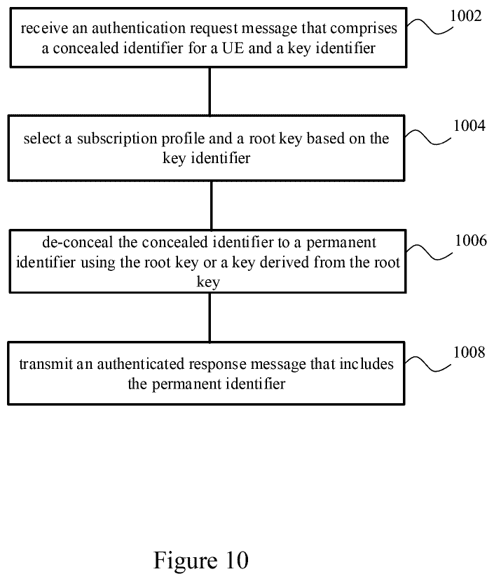

FIG. 10 illustrates a flowchart of a method in accordance with aspects of the present disclosure. The operations of the method may be implemented by an NE described herein. In some implementations, the NE may execute a set of instructions to control the function elements of the NE to perform the described functions.

At 1002, the method may include receiving an authentication request message that comprises a concealed identifier for a UE and a key identifier. The operations of 1002 may be performed in accordance with examples as described herein. In some implementations, aspects of the operations of 1002 may be performed by an NE as described with reference to FIG. 8.

At 1004, the method may include selecting a subscription profile and a root key based on the key identifier. The operations of 1004 may be performed in accordance with examples as described herein. In some implementations, aspects of the operations of 1004 may be performed by an NE as described with reference to FIG. 8.

At 1006, the method may include de-concealing the concealed identifier to a permanent identifier using the root key or a key derived from the root key. The operations of 1006 may be performed in accordance with examples as described herein. In some implementations, aspects of the operations of 1006 may be performed by an NE as described with reference to FIG. 8.

At 1008, the method may include transmitting an authenticated response message that includes the permanent identifier. The operations of 1008 may be performed in accordance with examples as described herein. In some implementations, aspects of the operations of 1008 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network function, a message that comprises a key identifier nonce and a key identifier hash chain length;
generate a hash chain using the key identifier nonce as an initial value, wherein the hash chain has the key identifier hash chain length;
select a last key identifier from the hash chain as a key identifier for a root key;
generate a concealed identifier for the UE using the root key or a key derived from the root key; and
transmit a message including the concealed identifier.

2. The UE of claim 1, wherein the at least one processor is further configured to cause the UE to:
before receiving the message from the network function, transmit, to the network function, a registration request message that comprises an initial key identifier for the UE and the concealed identifier.

3. The UE of claim 2, wherein the initial key identifier is a default key identifier, the last key identifier from the hash chain, or an intermediate key identifier from the hash chain.

4. The UE of claim 1, wherein the concealed identifier is a subscription concealed identifier (SUCI).

5. The UE of claim 1, wherein the hash chain is a truncated hash chain and the key identifier hash chain length is a truncated key identifier hash chain length.

6. The UE of claim 1, wherein the at least one processor is configured to cause the UE to generate the hash chain by:
performing multiple hash functions, using the key identifier nonce as an initial input, to output a hash chain having a first key identifier, one or more intermediate key identifiers, and the last key identifier,
wherein a quantity of the multiple hash functions is based on the key identifier hash chain length.

7. The UE of claim 6, wherein the at least one processor is further configured to cause the UE to:
truncate the first key identifier, the one or more intermediate key identifiers, and the last key identifier after outputting the last key identifier.

8. The UE of claim 1, wherein the at least one processor is further configured to cause the UE to:
truncate an output of each performed hash function of multiple hash functions before performing a subsequent hash function.

9. A network function for wireless communication, comprising:
at least one memory; and
at least one processor coupled with the at least one memory and configured to cause the network function to:
receive an authentication request message that comprises a concealed identifier for a user equipment (UE) and a key identifier;
select a subscription profile and a root key based on the key identifier;
de-conceal the concealed identifier to a permanent identifier using the root key or a key derived from the root key; and
transmit an authenticated response message that includes the permanent identifier.

10. The network function of claim 9, wherein the at least one processor is further configured to cause the network function to:
generate a key identifier nonce;
generate a hash chain having a key identifier hash chain length based on the key identifier nonce; and
transmit, via the authenticated response message, the key identifier nonce and the key identifier hash chain length.

11. The network function of claim 10, wherein the at least one processor is further configured to cause the network function to:
truncate the hash chain to generate a truncated hash chain,
wherein the key identifier hash chain length is a truncated key identifier hash chain length.

12. The network function of claim 9, wherein the concealed identifier is a subscription concealed identifier (SUCI) and wherein the permanent identifier is a subscription permanent identifier (SUPI).

13. The network function of claim 9, wherein the key identifier is a default key identifier default key identifier, a last key identifier from a previously generated hash chain, or an intermediate key identifier from the previously generated hash chain.

14. The network function of claim 9, wherein the network function is a unified data management (UDM) function, a subscription identity de-concealing function (SIDF), or an Authentication credential Repository and Processing Function (ARPF).

15. A method performed by a user equipment (UE), the method comprising:
receiving, from a network function, a message that comprises a key identifier nonce and a key identifier hash chain length;
generating a hash chain using the key identifier nonce as an initial value, wherein the hash chain has the key identifier hash chain length;
selecting a last key identifier from the hash chain as a key identifier for a root key;
generating a concealed identifier for the UE using the root key or a key derived from the root key; and
transmitting a message including the concealed identifier.

16. The method of claim 15, further comprising:
before receiving the message from the network function, transmitting, to the network function, a registration request message that comprises an initial key identifier for the UE and the concealed identifier.

17. The method of claim 15, wherein generating the hash chain includes:
performing multiple hash functions, using the key identifier nonce as an initial input, to output a hash chain having a first key identifier, one or more intermediate key identifiers, and the last key identifier,
wherein a quantity of multiple hash functions is based on the key identifier hash chain length.

18. A method performed by a network function, the method comprising:
receiving an authentication request message that comprises a concealed identifier for a user equipment (UE) and a key identifier;
selecting a subscription profile and a root key based on the key identifier;
de-concealing the concealed identifier to a permanent identifier using the root key or a key derived from the root key; and
transmitting an authenticated response message that includes the permanent identifier.

19. The method of claim 18, further comprising:
generating a key identifier nonce;
generating a hash chain having a key identifier hash chain length based on the key identifier nonce; and
transmitting, via the authenticated response message, the key identifier nonce and the key identifier hash chain length.

20. The method of claim 19, further comprising:
truncating the hash chain to generate a truncated hash chain,
wherein the key identifier hash chain length is a truncated key identifier hash chain length.
